(19) United States
(12) Patent Application Publication
(10) Pub. No.: US 2024/0278299 A1
(43) Pub. Date: Aug. 22, 2024

(54) PRINTING MACHINE WITH COLD FOIL ROLLER

(71) Applicant: Fergus CHOU, New Taipei City (TW)

(72) Inventor: Fergus CHOU, New Taipei City (TW)

(21) Appl. No.: 18/111,623

(22) Filed: Feb. 20, 2023

(51) Int. Cl. B21B 1/28; B41F 16/00; B41J 27/12

(52) U.S. Cl. CPC B21B 1/28; B41F 16/002; B41F 16/006; B41J 27/12

(57) ABSTRACT

A printing machine with a cold foil roller includes a printing plate roller, an ink roller set, a transfer roller, a material catching roller and a hollow roller inside a chassis. The hollow roller contains a wheel wall, a driving motor, an infeed wheel and an outfeed. The driving motor is connected to a control element, and the outfeed wheel has a cold foil with an end wound from a side inside the hollow roller to the outside and attached from an outer surface of the wheel wall to the other side inside the hollow roller and then fixed to the infeed wheel. The driving motor is provided for transmitting the infeed wheel to send/receive cold foil, and the driving motor rotates with the hollow roller asynchronously to avoid wasting the cold foil caused by the synchronous operation of the driving motor and the hollow roller.

### BACKGROUND OF THE DISCLOSURE

### 1. Technical Field

The present disclosure relates to a printing machine with a cold foil roller, and such machine is used for printing or cold foil printing.

### 2. Description of the Related Art

Printed materials such as books, newspapers, magazines, propaganda, posters and various product packages are widely circulated in the market. Besides their use as documents, records, information media, etc., people pay increasing attention to the visual aesthetics of the printed materials with the progress of the times, and more and more printed materials are used for advertising, decorating and packaging. The mature printing technology also brings out the need for different types of printing, among which cold foil printing with metallic texture is one of the popular ones.

With reference to FIG. 1 for a conventional printing machine 1, the printing machine 1 includes a plurality of rollers 11 installed the machine and used for printing. When each of the rollers 11 rotates, an ink is introduced to a cold coil grooved aluminum plate which is exclusively used for lithography, and then the ink in the aluminum plate is printed onto a rubber roller and finally transferred onto paper (or any other matter to be printed). If it is necessary to add cold foil treatment, then a plurality of transmission rollers 12 and a cold foil stamping roller 13 are installed at an end of each roller 11, and a transmission roller set 131 is installed next to the cold foil stamping roller 13 for receiving and sending a cold foil 14, and the cold foil 14 is wound onto the cold foil stamping roller 13. The transmission roller 12, the cold foil stamping roller 13 and the transmission roller set 131 rotate synchronously during the printing operation. When paper is entered between the transmission roller 12 and the cold foil stamping roller 13, the original printed position on the paper will stick with the part in contact with the cold foil 14 to complete the cold foil treatment.

Besides the original existing rollers 11 used for printing, the conventional printing machine 1 further adds the transmission roller 12, the cold foil stamping roller 13 and the transmission roller set 131 for the cold coil printing, but these additional rollers will increase the overall volume and purchase cost of the printing machine 1. Especially, in a large factory, many printing machines 1 must be purchased at the same time for printing. If the volume of the printing machine 1 is too large, the quantity of printing machines 1 accommodated in the factory will decrease, thus further reducing the overall printing throughput.

In the whole cold foil treatment process, the transmission roller 12, the cold foil stamping roller 13 and the transmission roller set 131 are rotated synchronously, so that after the cold foil treatment, some of the cold foils 14 which are not used will be rotated with the transmission roller set 131 and will be collected. With reference to FIG. 2 for the expanded contact surface of the transmission roller 12 and the cold foil stamping roller 13 during the rotation, the transmission roller 12 and the cold foil stamping roller 13 are arranged side by side and configured to be in corresponding positions with each other, wherein a first length L1 is defined as the total length of the circumference of the cold foil stamping roller 13 (that is the length that the roller turns in one round), and a first area A is defined as the effective range of the cold foil 14 used for the cold foil printing, and a second area B is defined as an invalid range of the cold foil 14 used for cold foiling printing, so that whenever the cold foil stamping roller 13 has turned through a distance equal to the first length L1 each time, a range of the cold foil 14 greater than the second area B has not been used. The small the first area A used, the greater the second area B produced. As a result, more cold foil 14 is wasted, and in the long run, it will cause a considerable burden on a company's costs and use of resources.

Therefore, this disclosure provides a feasible solution and discloses a cold foil roller structure that integrates the cold foil stamping roller and the transmission roller set into a single component and adopts an independent driving element to drive the cold foil, so as to avoid unnecessary waste of the cold foil that is continuously outputted by the cold foil stamping roller and also to reduce the overall space.

### SUMMARY OF THE DISCLOSURE

The present disclosure provides a printing machine with a cold foil roller, which includes: a printing plate roller, having a plate disposed on the printing plate roller, and two side edges of the plate being fixed to the printing plate roller, and the plate being pulled and attached to an outer surface of the printing plate roller and having an engraved groove formed on the plate and designed with a preset graphic; an ink roller set, installed and attached to a side of the printing plate roller and used to introduce an ink and water into the engraved groove; a transfer roller, installed and attached to another side of the printing plate roller and provided with a transfer layer; a material catching roller, installed and attached to a side of the transfer roller for receiving a printing carrier; and a hollow roller, installed and attached to a side of the material catching roller, and having a wheel wall with a material inlet and a material outlet formed on the hollow roller, a driving motor, an infeed wheel, a first inner wheel, a second inner wheel and an outfeed wheel which are installed in the hollow roller, and the driving motor being connected to a control element and provided for synchronously transmitting the infeed wheel and the first inner wheel, and the second inner wheel being disposed on a side of the first inner wheel, and the driving motor rotating asynchronously with the hollow roller through the setting of the control element, and the outfeed wheel having a cold foil with an end wound outwardly from the material outlet attached to an outer surface of the wheel wall to the material inlet, passed between the first inner wheel and the second inner wheel, and then fixed to the infeed wheel.

In a preferred embodiment, the printing plate roller, the ink roller set, the transfer roller, the material catching roller and the hollow roller are installed and integrated into a chassis.

In a preferred embodiment, the driving motor is a servo motor or a stepper motor.

In a preferred embodiment, the control element limits the driving motor based on a time or stroke condition to operate in a preset time or stroke within a specific time or stroke range.

In a preferred embodiment, the cold foil is a metal film.

### BRIEF DESCRIPTION OF THE DRAWINGS

FIG. 1 is a plan view showing the structural configuration of a traditional printing machine;

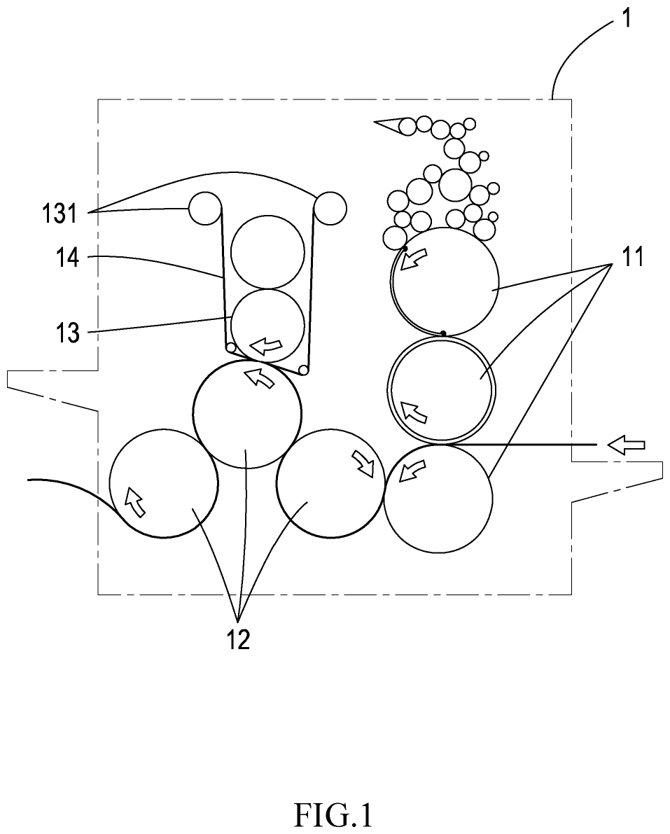

FIG. 2 is a schematic view showing the unfolded surfaces of a transmission roller and a cold foil stamping roller of a traditional printing machine;

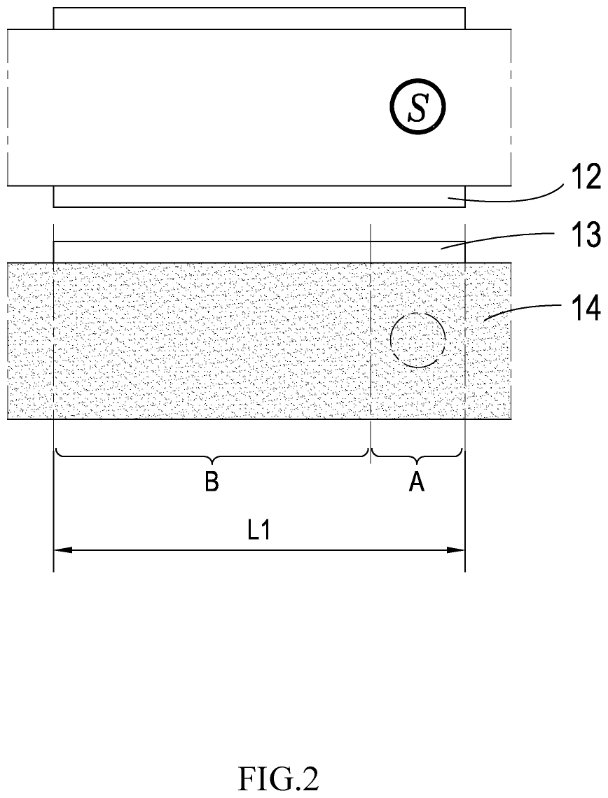

FIG. 3 is a plan view showing the overall structural configuration of a printing machine with a cold foil roller in accordance with this disclosure;

FIG. 4 is a cross-sectional view showing a structural configuration of a printing machine with a cold foil roller in accordance with this disclosure;

FIG. 5 is a plan view showing the overall structure of a printing machine with a cold foil roller when used for printing in accordance with this disclosure;

FIG. 6 is a schematic view showing the unfolded surfaces of a printing machine with a cold foil roller and a material catching roller in accordance with this disclosure;

FIG. 7 is a cross-sectional view of a printing machine with a cold foil roller when used for rolling in accordance with this disclosure;

FIG. 8 is a cross-sectional of a printing machine with a cold foil roller when used for cold foil printing in accordance with this disclosure; and

FIG. 9 is a schematic view of a cold foil after a printing machine with a cold foil roller performs cold foil printing in accordance with this disclosure.

### DESCRIPTION OF THE PREFERRED EMBODIMENTS

The objectives, technical contents and features of this disclosure will become apparent in the following detailed description of the preferred embodiments with reference to the accompanying drawings.

The term “on” used to describe a positional relation of a structure in the specification of this disclosure refers to any position at a surface of the structure, but it does not refer to the commonly known directionality of being “at the top of” or “above” the structure. The term “on” is used to describe the position of the structure. The terms “above” and “below” refer to the directionality and position of the structure under normal use.

The terms “fixed”, “mounted”, “arranged” or “installed” used to describe a structural combining relationship of a structure in the specification of this disclosure generally refer to the structural combining relationship of a plurality of structures that will not be easily separated or fallen apart after their combination, and it can be a fixed connection, a detachable connection, or an integral connection; it can also a mechanical connection or an electrical connection; or it can be a direct physical connection, or indirect physical connection through a medium, which can be the internal connection of two components, for example: using threads, tenons, fasteners, nails, adhesives, high-frequency waves, or any combination of the above.

The terms “connected” and “coupled” used to describe a structural combining relationship of a structure in the specification of this disclosure refer to the use of wires, circuit boards, network cables, Bluetooth or wireless networks to carry out electrical connection or network communication.

The terms “formed” or “extended” used to describe a structural combination relationship in this specification this disclosure generally refer to one or more structures which are combined into one piece in manufacturing, or the corresponding structures produced by different positions, shapes and functions.

The terms “inner side” or “inside” used to describe a structural position in this specification this disclosure generally refer to a position close to the center position of a structure, but it is not an exposed position; the term “inwardly” refers to a position close to the center of the structure, or towards a position that is not exposed; the terms “outer side” and “outside” refer to a position away from the center of the structure, or a position that is exposed; the term “outwardly” refers to a position away from the center of the structure, or towards a position that is exposed.

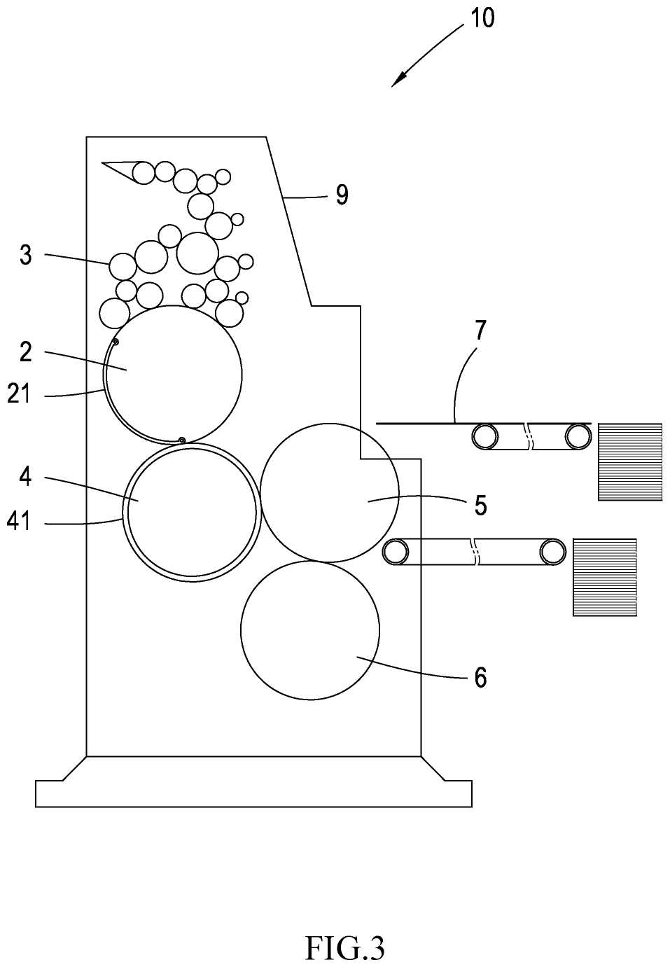

With reference to FIG. 3 for the structural assemblies of the printing machine with a cold foil roller in accordance with this disclosure, the printing machine includes a printing plate roller 2, an ink roller set 3, a transfer roller 4, a material catching roller 5 and a hollow roller 6.

The printing plate roller 2 has a plate 21, and two side edges of the plate 21 are fixed to the printing plate roller 2, and the plate 21 is pulled and attached to an outer surface of the printing plate roller 2, and an engraved groove is formed on the plate 21 and provided for printing.

The ink roller set 3 is installed and attached to a side of the printing plate roller 2, and used to introduce an ink and water into the engraved groove of the plate 21.

The transfer roller 4 is installed and attached to another side of the printing plate roller 2, and provided with a transfer layer 41.

The material catching roller 5 is installed and attached to a side of the transfer roller 4 and provided for receiving a printing carrier 7, and the printing carrier 7 is a printed matter of any material (usually paper).

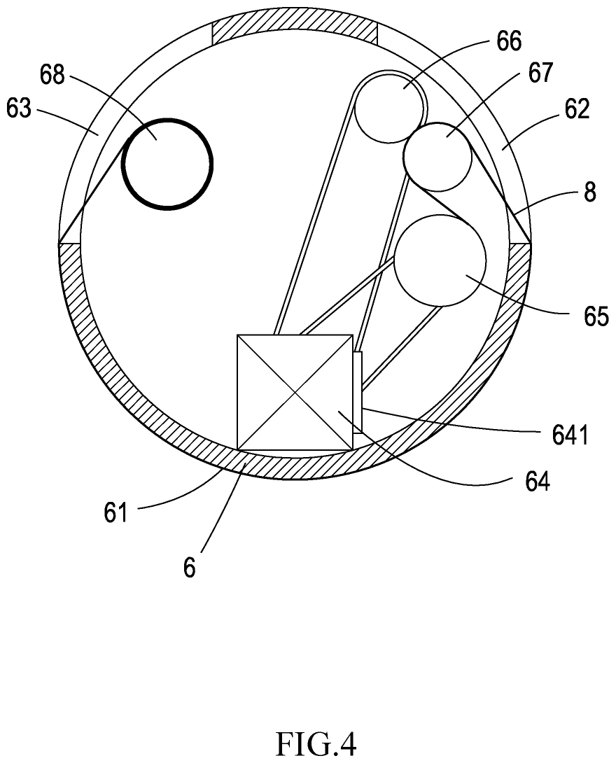

The hollow roller 6 is installed and attached to a side of the material catching roller 5. In FIG. 4, the hollow roller 6 includes a wheel wall 61, a material inlet 62 and a material outlet 63 formed on the wheel wall 61, and a driving motor 64, an infeed wheel 65, a first inner wheel 66, a second inner wheel 67 and an outfeed wheel 68 which are installed in the hollow roller 6, and the driving motor 64 is a servo motor or a stepper motor connected to a control element 641, and the driving motor 64 is provided for synchronously transmitting the infeed wheel 65 and the first inner wheel 66, and the second inner wheel 67 is disposed on a side of the first inner wheel 66.

The outfeed wheel 68 is provided for installing a cold foil 8, and an end of the cold foil 8 is wound outwardly from the material outlet 63 and attached to an outer surface of the wheel wall 61 to the material inlet 62, and passed between the first inner wheel 66 and the second inner wheel 67, and then fixed to the infeed wheel 65.

The printing plate roller 2, the ink roller set 3, the transfer roller 4, the material catching roller 5 and the hollow roller 6 are assembled to form a cold foil printing equipment 10, and the cold foil printing equipment 10 is installed and integrated in a chassis 9.

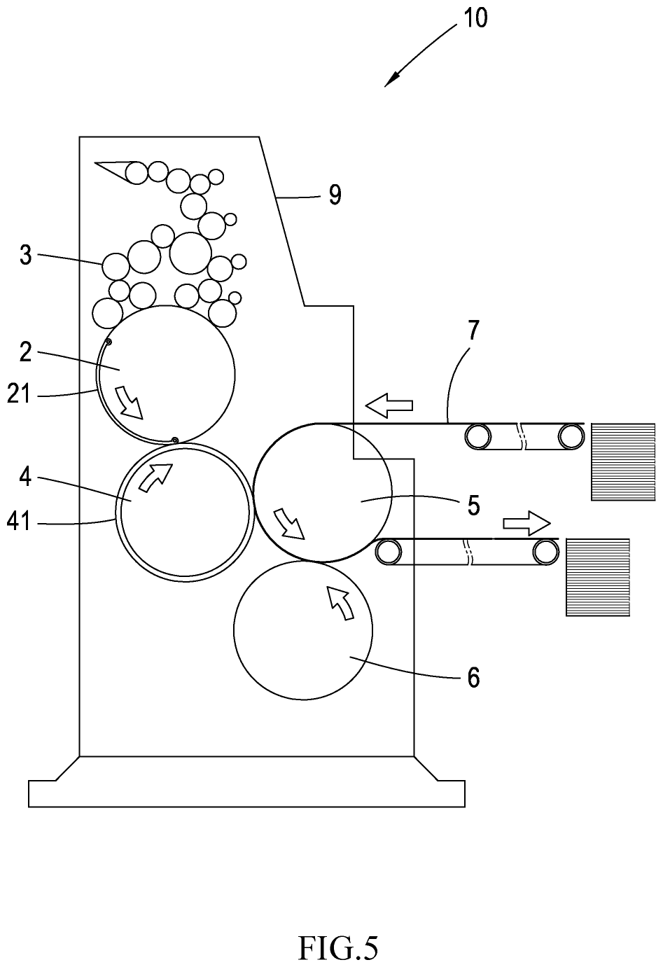

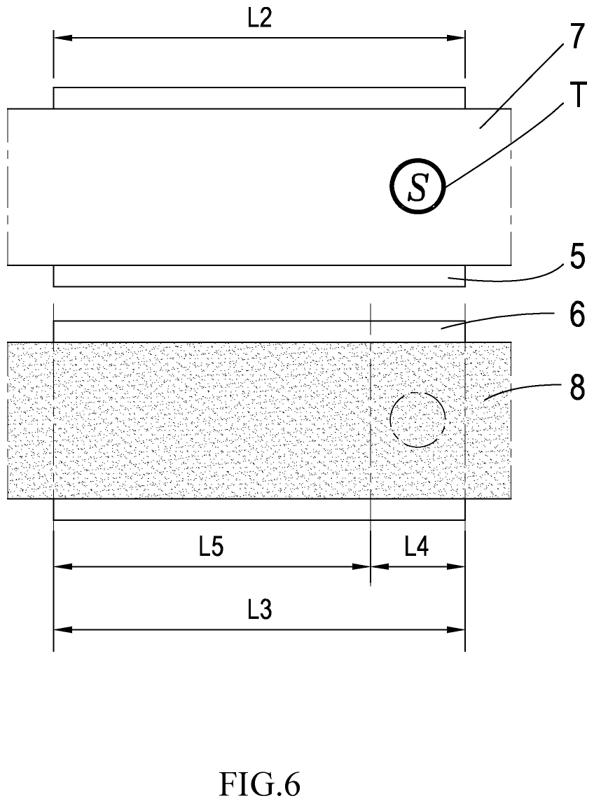

With reference to FIGS. 5 and 6 for a printing machine with a cold foil roller in accordance with this disclosure, when the printing plate roller 2 is rotated in a printing process, the ink of the ink roller set 3 is preferably brought into the engraved groove of the plate 21, and then the ink in the engraved groove is pressed and printed onto the transfer roller 4, such that the ink is printed in an opposite direction onto the transfer layer 41. After the printing carrier 7 is fixed and brought in, the material catching roller 5 touches the transfer roller 4 during the rotation and applies a pressure to transfer the ink on the transfer layer 41 onto the printing carrier 7, and the printing carrier 7 is printed with the preset graphic T and contact together with the material catching roller 5 with the hollow roller 6 again to carry out the subsequent cold foil process.

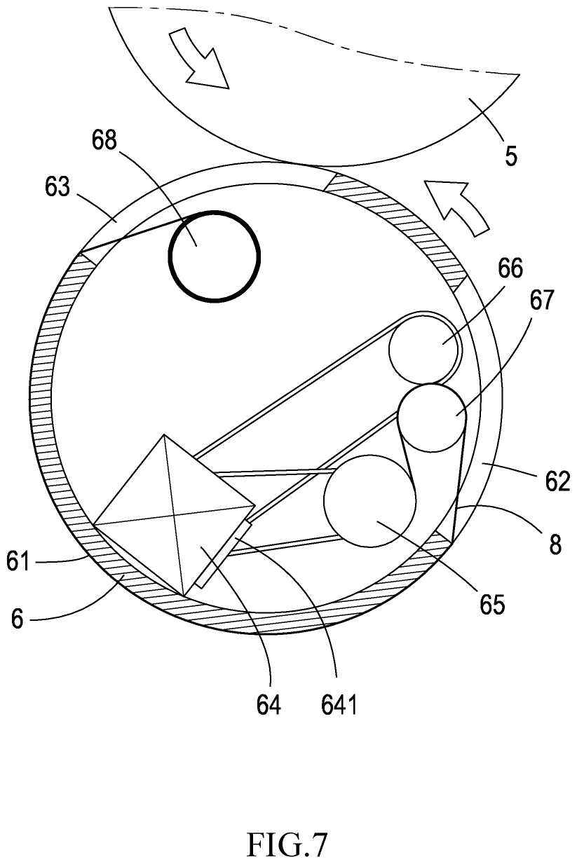

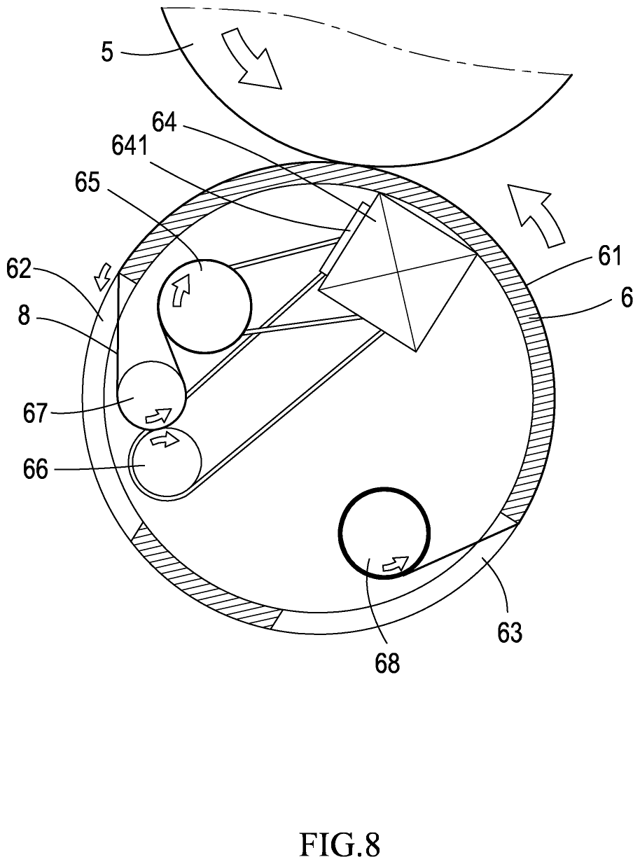

In FIG. 7, the material catching roller 5 and the hollow roller 6 roll synchronously during the cold foil process. In FIG. 6 and FIG. 8, once the cold foil 8 on the outer surface of the wheel wall 61 is in contact with the preset graphic T of the printing carrier 7, a part of the contact of the cold foil 8 with the preset graphic T will be stuck to the surface of the preset graphic T because the preset graphic T on the printing carrier 7 is sticky. After the cold foil treatment is completed, the material catching roller 5 continues to send out the printing carrier 7.

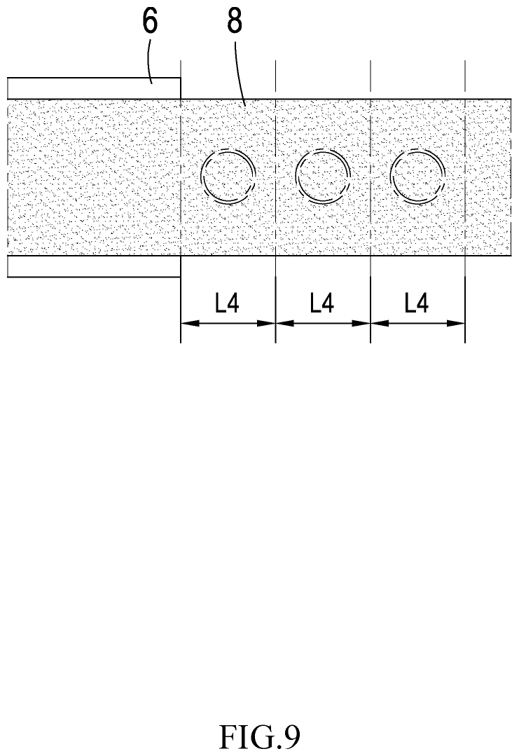

In FIG. 8, the driving motor 64 is turned on within a specific range of stroke during the cold foil treatment process. With reference to FIG. 6 for the expanded contact surfaces of the material catching roller 5 and the hollow roller 6 when these rollers are rotated, the material catching roller 5 and the hollow roller 6 are arranged side by side and configured to be in corresponding positions with each other, and the material catching roller 5 is fixed with the printing carrier 7, and the printing carrier 7 is printed with the preset graphic T, and the hollow roller 6 carries the cold foil 8, wherein a second length L2 is defined as the total length of the circumference of the material catching roller 5, a third length L3 is defined as the total length of the circumference of the hollow roller 6, a fourth length L4 is defined as an effective cold foil stroke length, and its length area represents the cold foil 8 corresponding to the effective range of the preset graphic T used for cold coil printing, a fifth length L5 is defined as an invalid cold foil stroke length, and its length area represents the cold foil 8 corresponding to the range other than the preset graphic T and not used for cold coil printing, and the second length L2 and the third length L3 are equal in length, and one of the second length L2 (or the third length L3) is used as one stroke, representing that both of the material catching roller 5 and the hollow roller 6 are rotated turned one round. With the stroke of each second length L2, the driving motor 64 is turned on to allow the cold foil 8 to move a distance equal to the fourth length L4. Therefore, the cold coil 8 can be used more effectively without unnecessary waste as shown in FIG. 9.

With reference to FIG. 8 for a printing machine with a cold foil roller in accordance with this disclosure, when the driving motor 64 is turned on, the infeed wheel 65 and the first inner wheel 66 are driven, so that the cold foil 8 is pulled out from the material outlet 63 by the outfeed wheel 68 and attached to an outer surface of the wheel wall 61 to the material inlet 62, and then rolled inwardly by the first inner wheel 66 and the second inner wheel 67 and restored in the infeed wheel 65, and the driving motor 64 can be limited to operate within a specific time or stroke range through the setting of the control element 641, and the conditional limitations of preset time or stroke, etc.

Compared with the related art, the printing machine with a cold foil roller in accordance with this disclosure has the following advantages:
1. Since an independent driving motor, and an outfeed wheel and an infeed wheel for receiving and sending the cold coil are installed in the hollow roller, therefore it is not necessary to continuously operate with the material catching roller for sending or receiving the cold foil, and the cold foil can be recycled after being consumed, so as to greatly reduce the waste of cold foil.
2. The outfeed wheel and the infeed wheel for sending and receiving the cold foil are designed in the hollow roller, so that the number of installed rollers and the space used can be reduced for the whole printing process. Especially, these wheels and the rollers such as the printing plate roller, ink roller set, transfer roller, etc. used for printing are integrated in one chassis to effectively reduce the chassis volume. In a large-scale factory, it is necessary to purchase many printing machines at the same time to carry out the printing process, so that the reduced chassis volume allows the factory to accommodate more printing machines to further improve the overall printing throughput.

While the disclosure has been described by means of specific embodiments, it is to be understood that the disclosure is not limited thereto. To the contrary, numerous modifications and variations could be made thereto by those skilled in the art without departing from the scope and spirit of the disclosure set forth in the claims.

What is claimed is:

1. A printing machine with a cold foil roller, comprising:
a printing plate roller, having a plate disposed thereon, and two side edges of the plate being fixed to the printing plate roller, and the plate being pulled and attached to an outer surface of the printing plate roller, and having an engraved groove formed on the plate and designed with a preset graphic;
an ink roller set, installed and attached to a side of the printing plate roller, for introducing an ink and water into the engraved groove;
a transfer roller, installed and attached on another side of the printing plate roller, and provided with a transfer layer;
a material catching roller, installed and attached on a side of the transfer roller, for receiving a printing carrier; and
a hollow roller, installed and attached on a side of the material catching roller, and having a wheel wall with a material inlet and a material outlet formed thereon, a driving motor, an infeed wheel, a first inner wheel, a second inner wheel and an outfeed wheel which are installed in the hollow roller, and the driving motor being coupled to a control element and provided for synchronously transmitting the infeed wheel and the first inner wheel, and the second inner wheel being disposed on a side of the first inner wheel, and the driving motor rotating asynchronously with the hollow roller through the setting of the control element, and the outfeed wheel having a cold foil with an end wound outwardly from the material outlet attached to an outer surface of the wheel wall to the material inlet, passed between the first inner wheel and the second inner wheel, and then fixed to the infeed wheel.

2. The printing machine with a cold foil roller according to claim 1, wherein the printing plate roller, the ink roller set, the transfer roller, the material catching roller and the hollow roller are installed and integrated into a chassis.

3. The printing machine with a cold foil roller according to claim 1, wherein the driving motor is a servo motor or a stepper motor.

4. The printing machine with a cold foil roller according to claim 1, wherein the control element limits the driving motor based on a time or stroke condition to operate at a preset time or stroke within a specific time or stroke range.

5. The printing machine with a cold foil roller according to claim 1, wherein the cold foil is a metal film.
